(19) United States
(12) Patent Application Publication
(10) Pub. No.: US 2008/0021856 A1
(43) Pub. Date: Jan. 24, 2008

(54) SELECTION PROTOCOLS FOR SELECTING DEFAULT REPORT TEMPLATES

(75) Inventors: Steven Lawrence Fors, Chicago, IL (US); Harry Philip Solomon, Highland Park, IL (US); Joji George, Kerala (IN)

Correspondence Address: PETER VOGEL;GE HEALTHCARE, 3000 N. GRANDVIEW BLVD., SN-477, WAUKESHA, WI, 53188, US

(73) Assignee: General Electric Company, Schenectady, NY (US)

(21) Appl. No.: 11/382,439

(22) Filed: May 9, 2006

(51) Int. Cl. G06F 17/30

(52) U.S. Cl. 707/1

(57) ABSTRACT

Various methods, systems, medium, and code are disclosed for selecting a default report template, particularly in a PACS environment. In general, the selection protocols entail at least one first axis that contains at least one searchable parameter and at least one second axis that contains at least one report template, arranged according to a pre-determined user hierarchy. At least one of the parameters is then mapped to at least one of the report templates in order to select a default report template for a desired radiological context based on the mapping.

### FIELD OF INVENTION

In general, the inventive arrangements relate to selection protocols, and more specifically, to methods, systems, mediums, and code for selecting default report templates.

### BACKGROUND OF INVENTION

For illustrative, exemplary, representative, and non-limiting purposes, preferred embodiments of the inventive arrangements will be described in terms of medical imaging equipment. For example, common medical imaging equipment includes equipment for radiology, functional imaging, molecular imaging, vascular imaging, fluoroscopy, mammography, neurology, oncology, radio pharmacology, x-ray, computed tomography (“CT”), nuclear medicine (“NM”), positron emission tomography (“PET”), magnetic resonance imaging (“MRI”), ultrasound, and the like. However, the inventive arrangements are not limited in this regard.

In common Picture Archival Communication Systems (“PACS”) environments, practitioners utilize hardware and software equipment to electronically capture, transmit, and store radiological images for immediate and subsequent viewing. In addition to viewing such images, practitioners also often view patient information associated with particular images, such as patients' names, gender, etc., and they often generate and view various reports associated with their particular patients' examinations. Thus, PACS configurations generally comprise electronic communication and image management systems that are typically used in medical settings, such as radiological departments within a hospital or other healthcare facilities. They often handle image related tasks, such as data acquisition, communication, display, manipulation, archiving, etc. to assist in radiological diagnostics.

Accordingly, practitioners' PACS reports often contain any number of observations from a particular radiological study, such as viewed from the images. Often, such reports will comprise written text in a specified language. However, it is often time-consuming and expensive for practitioners to attempt to create robust patient reports, particularly if they do not use some sort of a default report template to aid their efforts, yet standardized default report templates are not usually customizable to specific environments. In other words, typical PACS reports are not usually configurable based upon the specific natures of specific cases. Thus, common reporting protocols may only support one generic template for all reporting configurations, regardless of, for example, the particular parameters of a particular radiological context. In addition, many different practitioners commonly utilize different radiological reporting styles, including using different words, symbols, grammar, generalized language, and the like. As a result, PACS practitioners are usually unable to easily create robust reporting protocols for various groups of users in various radiological contexts.

As a result, protocols for selecting default report templates remain much sought after and highly desirable, particularly in PACS environments, thereby allowing practitioners to readily select default report templates according to, for example, the nature of a particular case, their style, individual reporting requirements, etc.

### SUMMARY OF INVENTION

In one embodiment, a method for selecting a default report template comprises configuring at least one first axis to contain at least one searchable parameter; configuring at least one second axis to contain at least one report template, arranged according to a pre-determined user hierarchy; and mapping at least one of the parameters to at least one of the report templates in order to select a default report template for a desired radiological context based on the mapping.

In another embodiment, a system for selecting a default report template comprises one or one or more servers providing at least one searchable parameter and containing at least one report template, arranged according to a pre-determined user hierarchy; a machine-executable program in communication with the one or more servers for mapping at least one of the parameters to at least one of the report templates in order to select a default report template for a desired radiological context based on the mapping.

In yet another embodiment, a machine-readable storage medium contains machine-executable code for instructing a machine to select a default report template by operating as follows: configuring at least one first axis to contain at least one searchable parameter; configuring at least one second axis to contain at least one report template, arranged according to a pre-determined user hierarchy; and mapping at least one of the parameters to at least one of the report templates in order to select a default report template for a desired radiological context based on the mapping.

And in still another embodiment, machine-executable code contained on a machine-readable storage medium for instructing a machine to select a default report template comprises code for configuring at least one first axis to contain at least one searchable parameter; code for configuring at least one second axis to contain at least one report template, arranged according to a pre-determined user hierarchy; and code for mapping at least one of the parameters to at least one of the report templates in order to select a default report template for a desired radiological context based on the mapping.

### BRIEF DESCRIPTION OF SEVERAL VIEWS OF THE DRAWINGS

A clear conception of the advantages and features constituting inventive arrangements, and of various construction and operational aspects of typical mechanisms provided by such arrangements, are readily apparent by referring to the following illustrative, exemplary, representative, and non-limiting figures, which form an integral part of this specification, in which like numerals generally designate the same elements in the several views, and in which:

FIG. 1 depicts a high-level schematic representation of selection protocols for selecting default report templates; and

FIG. 2 depicts a high-level schematic representation of representative interaction between one or more servers and a client application implementing the selection protocols of FIG. 1.

### DETAILED DESCRIPTION OF PREFERRED EMBODIMENTS

Referring now to the figures, preferred embodiments of the inventive arrangements will be described in terms of medical imaging equipment. However, the inventive arrangements are not limited in this regard. For example, while variously described embodiments provide protocols for selecting default report templates following a patient's radiological examination in a PACS environment, other contexts are also hereby contemplated, including various other consumer, industrial, radiological, and inspection systems, and the like.

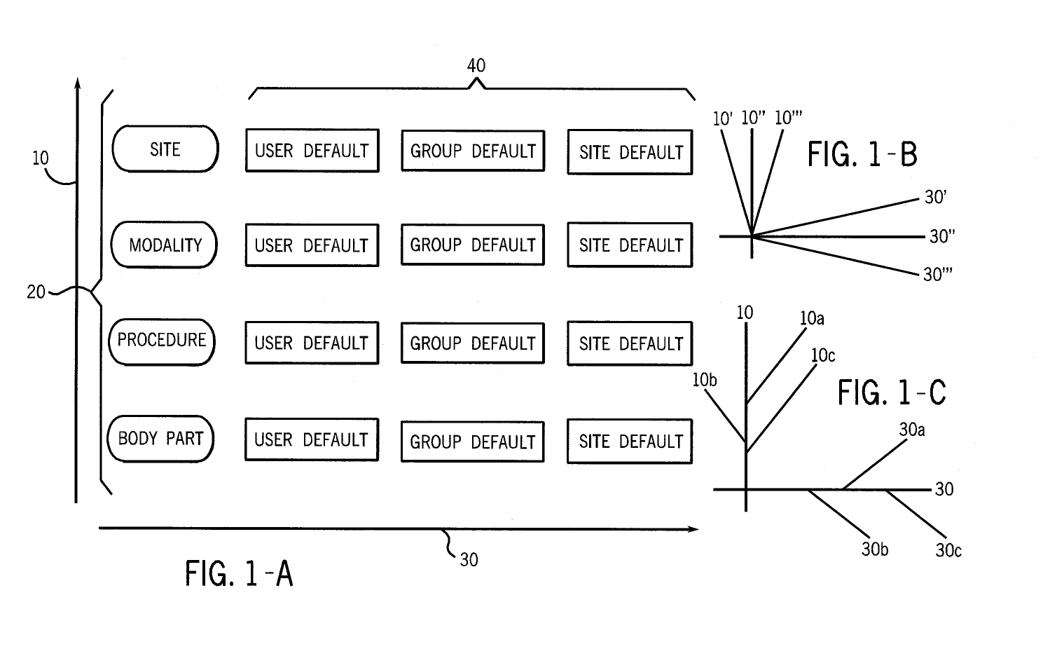

Referring now to FIGS. 1-A through 1-C, at least one or more first axes 10 contain at least one or more searchable parameters 20 that define at least one radiological context. Preferably, the parameters 20 may include common factors that can be grouped together under one or more common classifications of a typical radiological context. For example, practitioners may want to group common parameters 20 together by body part, procedures, modalities, sites, and the like.

In addition, multiple first axes 10 are also possible, wherein each first axis e.g. 10′, 10″, 10′″, etc. corresponds to at least one main classification of a given radiological context. For example, main classifications of a given radiological context could include first axes 10 that correspond to at least one of the following: type of setting, type of procedure, type of service provider, type of function/recipient, temporal contexts, and the like.

In addition, one or more of the first axes 10 may also contain one or more sub-axes e.g. 10a, 10b, 10c, etc. which can be further arranged according to at least one of the sub-classifications of a given radiological context. For example, axial and sub-axial parameters could include any of the following, and the like:
1) Setting Types: hospitals, outpatient imaging centers, primary care offices, etc.;
2) Procedure Types: modality, anatomy, perfusion studies, X-rays, cardiac catheters, etc.;
3) Service Provider Types: radiologists, nurses, sonographers, etc.;
4) Function/Recipient Types: preliminary or finding or referring or reporting providers, administrators, patient instructions, etc.; and
5) Temporal Contexts: current procedures, patient histories, treatment plans, etc.
   As such, any one of the one or more first axes e.g. 10′, 10″, 10′″, etc. or sub-axes e.g. 10a, 10b, 10c, etc. may be orthogonal or non-orthogonal.

Regardless, in a preferred embodiment, at least one of the first axes 10 is preferably expressed in Extensible Markup Language (“XML”) format, a well-known communication standard for facilitating and enabling data definition, transmission, validation, and interpretation between different applications, organizations, and users.

Likewise, at least one or more second axes 30 contain at least one or more report templates 40, one of which will be selected as a default report template 40* for a given radiological context. Preferably, the report templates 40 are configured according to a pre-determined hierarchy. For example, they may be arranged according to an individual user's default (e.g., an individual user's preferred hierarchy), a group's default (e.g., a user group's preferred hierarchy), or a site default (e.g., a site's preferred hierarchy), preferably arranged in a pre-determined order in order to suit a particular practitioner, group of practitioners, context, or the like.

Like the one or more first axes 10, the one or more second axes 30 can also be arranged as one or more second axes e.g. 30′, 30″, 30″′, etc. or sub-axes e.g. 30a, 30b, 30c, etc. and preferably expressed in XML format. Regardless, at least one of the parameters 20 on at least one of the first axes 10 is then mapped to at least one of the report templates 40 on at least one of the second axes 30 such that at least one report template 40 substantially matches a desired radiological context and is thus selected as the default report template 40* based on the parameters 20 for that radiological context. For example, in at least one preferred embodiment, a numerical or other score can be calculated for one or more of the selected report templates 40, wherein the report template 40 with a particular correlation score (e.g., highest or lowest, closest to or furthest from a particular number, etc.) is thus selected as the default report template 40* based on the mapping for that radiological context.

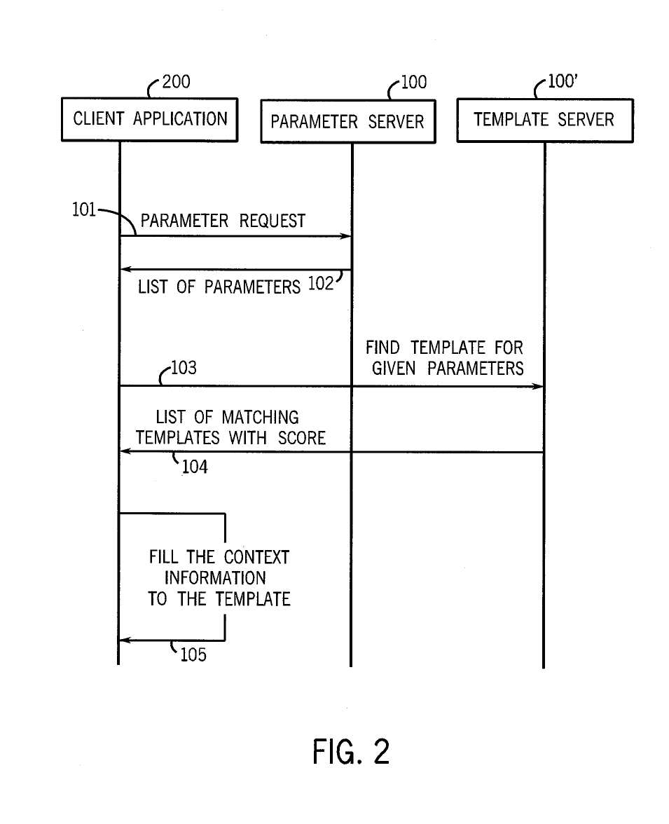

Referring now to FIG. 2, a first server 100 contains one or more of the searchable parameters 20, configured to correspond to the one or more radiological contexts of FIG. 1. Likewise, the same or a second server 100′ contains one or more of the report templates 40, similarly configured to correspond to the one or more parameters 20 of the one or more radiological contexts of FIG. 1.

Preferably, a machine-executable program, such as a client application 200, is then configured for searching and mapping at least one of the parameters 20 to at least one of the report templates 40. Preferably, this program is configured to select at least one of the report templates 40 as the default report template 40* in order to substantially match with a desired radiological context based on the parameters 20 of the desired radiological context. In other words, the one or more parameters 20 of a desired radiological context are mapped with the one or more report templates 40, and at least one report template 40 that substantially matches with the desired radiological context can then be selected as the desired default report template 40*.

In a preferred embodiment, for example, the program can calculate, derive, and/or append a correlation score for each report template 40, and the report template 40 that is configured with a particular correlation score (e.g., highest or lowest, closest to or furthest from a particular number, etc.) can then be selected as the default report template 40*.

In a preferred embodiment, for example, interaction and operation can thus proceed as follows: a first server 100 receives a parameter request from a client application 200 in a step 101, which can then return thereto a list of searchable parameters 20 applicable for that current context in a step 102. The client application 200 can then search for applicable report templates 40 from the same or a second server 100′ in a step 103 based on the parameters 20, which can then return thereto a list of matching templates 40 in a step 104. The client application 200 can then sort and display one of the report templates 40 as the chosen default report template 40* and auto-fill contextual information into the template in a step 105, as desired. And the lists of parameters 20 and report templates 40 can be kept as up-to-date as desired.

In at least one embodiment, the report template 40 is preferably of XML type and may include a plurality of tokens. Thus, the servers 100 or client application 200 can be configured to fill the tokens with information corresponding to the desired radiological context. The information may include data on patients, an exam, a series, a language, etc., and it can be used to create or populate the default report template 40*.

The inventive arrangements can be realized in hardware, software, firmware, or a combination thereof. A visualization tool according to the inventive arrangements can be embodied in a centralized fashion on one computer system or in a distributed fashion, in which different elements are spread out across several interconnected computer systems. Any kind of computer system—or other apparatus adapted for carrying out the methods described herein—is suitable. A typical combination of hardware, software, and firmware could be a general purpose computer system with a computer program that, when being loaded and executed by known techniques, controls the computer system such that it carries out the methods described herein. The inventive arrangements can also be embedded in a computer program product that comprises various features enabling implementation of certain of the methods described herein, and which—when loaded into or onto a computer system—is able to carry out or execute these methods.

Accordingly, a machine-readable storage medium containing machine-executable code for instructing a machine to operate in a specified fashion is also contemplated, as is the machine-executable code that is contained on the machine-readable storage medium. In a preferred embodiment, this machine may be a computer, the machine-readable storage medium may be a computer-readable storage medium, and the machine-executable code may be computer-executable code.

In this context, machine and computer-readable storage medium and machine and computer-executable code could include any expression, in any language, code, or notation, of a set of instructions or commands that are intended to or do cause a system having an information processing capability to perform a particular function, either directly or indirectly, or after either or both of the following: i) conversion to another language, code, or notation, or ii) reproduction in a different material form. This is one possibility for implementing some of the various technical effects of the inventive arrangements.

It should be readily apparent that this specification describes illustrative, exemplary, representative, and non-limiting embodiments of the inventive arrangements. Accordingly, the scope of the inventive arrangements are not limited to any of these embodiments. Rather, various details and features of the embodiments were disclosed as required. Thus, many changes and modifications—as readily apparent to those skilled in these arts—are within the scope of the inventive arrangements without departing from the spirit hereof, and the inventive arrangements are inclusive thereof. Accordingly, to apprise the public of the scope and spirit of the inventive arrangements, the following claims are made:

What is claimed is:

1. A method for selecting a default report template, comprising:
configuring at least one first axis to contain at least one searchable parameter;
configuring at least one second axis to contain at least one report template, arranged according to a pre-determined user hierarchy; and
mapping at least one of the parameters to at least one of the report templates in order to select a default report template for a desired radiological context based on the mapping.

2. The method of claim 1, wherein the mapping comprises calculating a correlation score between at least one of the parameters and at least one of the report templates.

3. The method of claim 2, wherein the default report template is selected based on the correlation score.

4. The method of claim 1, wherein the user hierarchy comprises one or more of an individual hierarchy, group hierarchy, and site hierarchy.

5. The method of claim 1, wherein the user hierarchy is selected according to the radiological context.

6. The method of claim 1, wherein at least one of the first axes comprises one or more sub-axes.

7. The method of claim 6, wherein at least one of the sub-axes is arranged according to at least one main classification of the radiological context.

8. The method of claim 6, wherein at least one of the sub-axes is non-orthogonal.

9. The method of claim 1, wherein the default report template is expressed in XML format.

10. The method of claim 1, wherein the method is configured for use in a PACS environment.

11. A system for selecting a default report template, comprising:
one or more servers providing at least one searchable parameter and containing at least one report template, arranged according to a pre-determined user hierarchy;
a machine-executable program in communication with the one or more servers for mapping at least one of the parameters to at least one of the report templates in order to select a default report template for a desired radiological context based on the mapping.

12. The system of claim 11, wherein the system calculates a correlation score between at least one of the parameters and at least one of the report templates.

13. The method of claim 12, wherein the system selects the default report template based on the correlation score.

14. The system of claim 11, wherein the default report template is expressed in XML format.

15. The system of claim 11, wherein the system is adapted for use in a PACS environment.

16. A machine-readable storage medium containing machine-executable code for instructing a machine to select a default report template by operating as follows:
configuring at least one first axis to contain at least one searchable parameter;
configuring at least one second axis to contain at least one report template, arranged according to a pre-determined user hierarchy; and
mapping at least one of the parameters to at least one of the report templates in order to select a default report template for a desired radiological context based on the mapping.

17. The machine-readable storage medium of claim 16, wherein the medium is configured for use in a PACS environment.

18. Machine-executable code contained on a machine-readable storage medium for instructing a machine to select a default report template, comprising:
code for configuring at least one first axis to contain at least one searchable parameter;
code for configuring at least one second axis to contain at least one report template, arranged according to a pre-determined user hierarchy; and
code for mapping at least one of the parameters to at least one of the report templates in order to select a default report template for a desired radiological context based on the mapping.

19. The machine-executable code of claim 18, wherein the code is configured for use in a PACS environment.
